(19) United States
(12) Patent Application Publication
(10) Pub. No.: US 2012/0127759 A1
(43) Pub. Date: May 24, 2012

(54) LED LIGHT HAS BUILT-IN PROJECTION LIGHT AND NIGHT LIGHT

(76) Inventor: Tseng-Lu CHIEN, Walnut, CA (US)

(21) Appl. No.: 12/948,953

(22) Filed: Nov. 18, 2010

(51) Int. Cl. F21V 33/00

(52) U.S. Cl. 362/641

(57) ABSTRACT

The LED light has build in project light and night light to offer at 2 functions to people for dark environment to make big improvement to people for only single project light unit. The said project light can project any display-unit from geometric shape, digital data, wireless digital data, LCD screen means, TFT screen means or any other display-device for desired sized image on preferred surface with enlarge the display-unit original size to let people eyes to see. The build-in night light help people to see things under dark environment.

This filing related to co-inventor's prior patent applications Ser. Nos.

12/624,621, 12/622,100, 12/318,471, 12/318,470, 12/318,473, 12/292,153, 12/232,505, 12/232,035, 12/149,963, 12/149,964, 12/073,095, 12/073,889, 12/007,076, 12/003,691, 12/003,809, 11/806,711, 11/806,285, 11/806,284, 11/566,322, 11/527,628, 11,527,629, 11/498,874, 12/545,992, 12/806,711, 12/806,285, 12/806,284, 12/566,322, 12/527,628, 12/527,629, 12/527,631, 12/502,661, 11/498,881, 11/255,981, 11/184,771, 11/152,063, 11/094,215, 11/092,742, 11/092,741, 11/094,156, 11/094,155, 10/954,189, 10/902,123, 10/883,719, 10/883,747, 10/341,519, 12/545,992, 12/292,580, 12/710,918, 12/622,000 12/710,561, 12/710, 12/711,456, 12/771,003

This is patent application related to co-inventor's prior filing on

Nov. 5^{th} 2010 for Laser project light.

This is patent application related to co-inventor's prior fling on Nov. 5^{th} 2010 for LED Lava light.

This is patent application related to co-inventor's prior filing on

Nov. 5^{th} 2010 for LED light fixture has outlets and removable outlet unit(s).

This is patent application related to co-inventor's prior filing

Ser. No. 12/771,003

Field on Apr. 30, 2010 for LED has plurality of project means

This is patent application related to co-inventor's prior filing

Ser. No. 12/711,456

Field on Feb. 25, 2010 for LED power failure Light

This is patent application related to co-inventor's prior filing

Ser. No. 12/710,561

Field on Feb. 25, 2010 for LED light device has special effects

This is patent application related to co-inventor's prior filing

Ser. No. 12/710,918

Field on Feb. 25, 2010 for LED light device has more than 1 reflective means for plurality of image

This is patent application related to co-inventor's prior filing
Ser. No. Nov. 24, 2009 file for the “project device or assembly for variety of LED light”

This is patent application related to co-inventor's prior filing
Ser. No. 12/622,000
Field on Nov. 24, 2009 file for the “Interchangeable Universal Kits for all LED light”

This is patent application related to co-inventor's prior filing
Ser. No. 12/318,471
   Field Dec. 30, 2008 file for the “LED night light with pinhole imaging”

This is patent application related to co-inventor's prior filing
Ser. No. 12/318,470
   Field Dec. 24, 2008 file for the “LED night light with Projection features”

This is patent application related to co-inventor's prior filing
Ser. No. 12/318,473
Field Dec. 8, 2008 file for the “LED night light with laser or hologram element”

This is patent application related to co-inventor's prior filing
Ser. No. 12/292,153
   Field Nov. 8, 2008 file for the “LED night light with Projection or imaging features”

This is patent application related to co-inventor's prior filing
Ser. No. 12/232,505
Field Sep. 16, 2008 file for the “LED night light with Projection features”

This is patent application related to co-inventor's prior filing
Ser. No. 12/149,963
Filed on Apr. 21, 2008 file for the “Removable LED light device.

This is patent application related to co-inventor's prior filing
Ser. No. 12/149,964
Filed on Apr. 21, 2008 file for the “Surface Mounted Device with LED light”.

This is patent application related to co-inventor's prior filing
Ser. No. 12/073,095
Filed on Feb. 29, 2008 file for the “LED Track light device.

This is patent application related to co-inventor's prior filing
Ser. No. 12/073,889,
filed on Feb. 12, 2008 file for the “LED light with changeable position with Prefereable power source”.

This is patent application related to co-inventor's prior filing
Ser. No. 12/007,076,
filed on Jan. 7^{th} 2008 file for the “LED light with changeable geometric system”

This is patent application related to co-inventor's prior filing
Ser. No. 12/003,691, filed on Dec. 31^{th} 2007 file for the “LED light with changeable geometric dimension features”

This is patent application related to co-inventor's prior filing
Ser. No. 12/003,809, filed on Jan. 2, 2008 file for the “LED light with changeable features”

This is patent application related to co-inventor's prior filing
Ser. No. 11/806,711 filed on Apr. 30, 2007 file for the “Multiple LED light with adjustable angle features”

This is patent application related to co-inventor's prior filing
Ser. No. 11/806,285.
LED Night light with outlet device filed on Apr. 30, 2007

This is patent application related to co-inventor's prior filing
Ser. No. 11/806,284
LED Night light with more than 1 optics means filed on Apr. 28, 2007

This is patent application related to co-inventor's prior filing
Ser. No. 11/527,628.
Multiple function Night light with air fresher filed on Sep. 27, 2006.

This is patent application related to co-inventor's prior filing
Ser. No. 11/527,629.
LED Night light with interchangeable display unit filed on Sep. 27, 2006.

This is patent application related to co-inventor's prior filing
Ser. No. 11/498,874.
Area illumination Night light filed on Aug. 4, 2006.

This is patent application related to co-inventor's prior filing
Ser. No. 11/527,631.
LED Time piece night light field on Sep. 27, 2006.

This is patent application related to co-inventor's prior filing
Ser. No. 12/545,992 LED time piece Night light filed division of 11/527,631 on Aug. 24, 2009.

This is patent application related to co-inventor's prior filing
Ser. No. 12/292,580
LED Time Piece Night light filed division of 11/527,631 on Aug. 24, 2009.

This is patent application related to co-inventor's prior filing
Ser. No. 11/498,881, Poly Night light filed on Aug. 4, 2006.

This is patent application related to co-inventor's prior filing
Ser. No. 11/255,981, Multiple light source Night Light filed on Oct. 24^{th} 2005.

This is patent application related to co-inventor's prior filing
Ser. No. 11/184,771 Light Device with EL elements field on Oct. 11^{th} 2005

This is patent application related to co-inventor's prior filing
Ser. No. 11/1152,063 Outlet adaptor with EL field on Jun. 5, 2005

This is patent application related to co-inventor's prior filing
Ser. No. ______.

This is patent application related to co-inventor's prior filing
Ser. No. 11/094,215, filed Mar. 30^{th} 2005 LED Night light with Liquid optics medium.

This is patent application related to co-inventor's prior filing
Ser. No. 11/092,741, filed Mar. 30^{th} 2005 Night light with fiber opotics.

This is patent application related to co-inventor's prior filing
Ser. No. 10/883,747, filed Jul. 6^{th} 2004 Fiber Optic light kits for footwear.

This is patent application related to co-inventor's prior filing
Ser. No. 11/498,874,
Area Illumination for LED night light

This is patent application related to co-inventor's prior filing
Ser. No. 11/527,629.
Time Piece with LED night light,

This is patent application related to co-inventor's prior filing
Ser. No. 11/527,628. Multiple Function Night light with Air Freshener

This is patent application related to co-inventor's prior filing
Ser. No. 11/806,284
LED Night light with more than one optics mediums

This is patent application related to co-inventor's prior filing
Ser. No. 11/806,285
LED Night Light with multiple function

This is patent application related to co-inventor's prior filing
Ser. No. 11/806,711
Multiple LEDs Light with adjustable angle function

Above listed prior filing case related apply physic optic theory to the said LED light for outdoor or indoor application powered by alternative current (hereafter as AC) or direct current (hereafter as DC) connect by the electric cored & its plug for outlet, or battery, or transformer, or solar, or other power source which same as current invention to apply the physics optics theory to create plurality of LED light beam to make illumination for the said close area(s), or remote-away distanced-area(s) by said project means which present to viewers which may further incorporate with same inventor's other features which may in any combination from the selection including more than 1 light source, more than 1 function, more than 1 optics means, more than 1 project means with super power saving circuit and cost saving concept.

### BACKGROUND

The market available night light has no projection function so the co-inventor filed a lot of prior arts. The said night light for current invention have to emphasize the said night light only the for the night light are powered by outlet power source by prong means but it also cover the night light which for desk top or any other location which means can offer the light illumination for people during the night time for indoor or outdoors use so it also cover the any light device which has the night light has build-in project light for any purpose.

From market place, the said project light by any light source anywhere at toy market but it is no any project light has build-in night light because the night light need continuously power source so none of market items has build-in night light of any power source. Furthermore, the project light majority are powered by batteries which can not has continuously to turn on old bulb light source because it will last less than several hours. Now, come out the LED as power saving so can get tens of hours if incorporated with co-inventor's power saving circuit (Ser. No. 12/71,456 and other co-pending prior filing case), then it will last more longer for times. The co-inventor filed for LED night light has project means as (Ser. No. 12/232,505, 12/292,153, 12/318,473 now allowanced) which are overcome all market single project light for toy or hand-held or desk top as below listed difference:

The major difference between toy market and desk top project light powered by batteries at following points:

(a) No continuously switch position to keep night light turn on all the time.
(b) No housing parts to be designed to allow project light to sit on the surface.
(c) No build-in Night light—Majority desk top projection light no design the continuously turn-on night light by switch means, it even do not have steady-on select switch.
(d) No power saving circuit selection—Because earlier items powered by Bulb which has super big power consumption, so majority has no night light function.
(e) No focus design for long distance projection for clear image—Majority is short distance from projection head to the surface to see clear image which is not longer than people's one arms total length. Kids Toy major for project to desk surface or near the wall, so clear image show out for close distance. More larger image will not clear at all.
(f) No adjustable focus features for long distance beyond human one arms distance
(g) No swivel, spin, rotate project head design to allow image can change position at any time and stay there while put project light on surface—because hand carry items no need spin, it can change projection direction just by hand.

The features of current Project light has build-in Project light and Night light as below:
(1) The current invention for LED light has build-in Project light and night light connect for outlet power source or battery (Energy storage means) power source can offer the project image, time, weather, message, display, digital data, cartoon characters, advertisement, seasonal data, promotion art, or other any signals to people and the desired night light which can have all kind of the light source which available from conventional market place is very good combination.
(2) The current invention for LED light has build-in project light and night light which incorporated with desired combination select from g switch means, conductive means, sensor means, remote control means, wireless means, digital data means, digital data, transmission means, photo sensor mans, manual switch means, automatically means, motor means, gear set means, swivel means, rotating means, spin means, USB means, digital data storage means to have the proper function to make the said Project light has desired functions, effects, performance to offer the above listed projection purpose.
(3) The current invention for LED light has build-in Project light and night light which the project light or night light can be turn on and turn off under predetermined time, a period of time with desired functions which selected from any available light performance selected from market place.
(4) The current invention project light can has extra features can select from group combination including (4a) focus adjustable, (4b) project head changeable position or orientation to make image present any where as desired, (4c) swivel or rotate or spin for project head, (4d) proper housing design to allow unit can install on any surface without movement, (4e) motor means to make image with continuously changing, (4f) gear set means to make image with desired rotate circuit per minutes, (4g) image appear on long distance away from project head, (4h) desk top bas build in light with switch to turn on and turn on for longer period of time.
(5) The current invention project light focus is designed for long distance which at least longer than people one arms length.
(6) The current invention project light focus project image at least over 3 feet distance or more.

### DRAWINGS

FIG. 1: Disclosure the 1^{st} embodiment which has build-in project light and night light comsist of project means, more than one light means, swivel means or rotate or spin means to change project means' direction or orientation. The Project light incorporate switch means, sensor means, or other means to make the said project light or night light to turn-on and turn off as requirement. The power source as this embodiment is powered by outlet power source by prong means.

FIG. 2 and FIG. 3 and FIG. 4 and FIG. 5: Disclosure the detail construction of the preferred embodiment 1. Show the time display project light has build-in project light and night light which is for a time project light which has front housing, back housing, more than one of LEDs, prong means, sensor means, battery cover, batteries, time adjustable switchs, manual switchs, photo sensor means, inner circuit means, LCD display means, digital data display means, swivel or rotate or spin means to allow the project head change position, base spin or swivel or rotate means (housing has movable features), retractable or foldable prong, housing means can install prong means or energy storage means such as batteries, switch means arrange on desired location on balls or base, time related parts & accessories arranged in one areas instead of too many electric signal delivery needed while arrange more than one area.

These illustration show all the FIG. 1 preferred construction for time projection light has build-in time related parts & accessories and all preferred construction.

FIG. 6, FIG. 7, FIG. 8, FIG. 9, FIG. 10: Disclosure the above FIG. 1,2,3,4,5 for the functions of build-in project light and night light from different viewing angle.

FIG. 11, FIG. 12: Disclosure the preferred FIGS. 1 to 10 embodiment with different shape of co-pending filing case preferred embodiment of Series number (12/624,621) FIG. 16-1 of prior filing case # I I and co-pending filing “LED projection light has more than one function” FIG. 5 and FIG. 5-1 compare with current invention construction. Current invention can has horizon 0 to 360 degree and vertical 0-360 degree to make image project to anywhere. The earlier prior filing which can have horizon 0 to 360 degree but the Vertical has limited angles to make image projection for some limitation not anywhere. Because the current one the housing can be removable (Y-Frame can be rotating 0 to 360 degree and ball itself can rotate from 0 to 360 degree).

### DETAIL DESCRIPTION

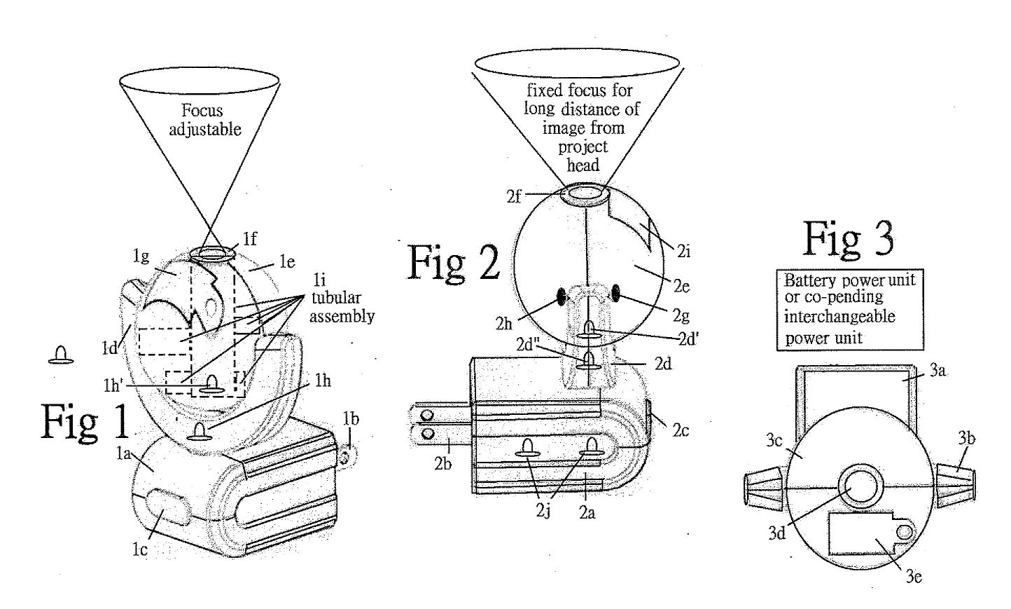

FIG. 1 and FIG. 1-a: Disclosure the 1^{st} embodiment of LED light which has build-in project light (1f) and night light (1h). From FIG. 1-a, at least one project light has desired parts & accessories may select from group combination from tubular assembly means (1i), telescope means (not shown), optics lens means (1-j), been display-unit means assembly (1f)(10g), film, LCD means (1f), TFT means (1f), digital data means (1f), wireless digital means (1f), time piece means (1f), weather means (1f), screen means (1f), light block out means (1d), fix means (1-d1), transparent means (open areas or display-unit segments or reverse or others), translucent means (display-unit background or reverse or others), opening means, cut-out means (1-i′″) (1-i″″), LED means (1-c), light means (1-c as other light source), lens assembly, attachment means (1-n) (1-p) (1-n′) (1-p′), support means (1-d2), or other parts & accessories (not shown) to project image, time, weather, message, display, digital data, cartoon characters, advertisement, seasonal data, promotion art, light beams only, or any geometric art, drawing, photos, negative, positive film, LCD screen image, TFT screen image, display-unit, or any signals, message that people eyes can be recognized to people to be seen by people eye.

From FIG. 1, The LED light may has more than one light means (1h) (1h′), swivel means (extend poles or rotate Y-frame) or rotate or spin means to change project means' direction or orientation. The Project light incorporate switch means (1c), sensor means (1c), or other means (not shown) to make the said project light or night light to turn-on and turn off as requirement. The power source as this embodiment is powered by outlet power source by prong means (1b).

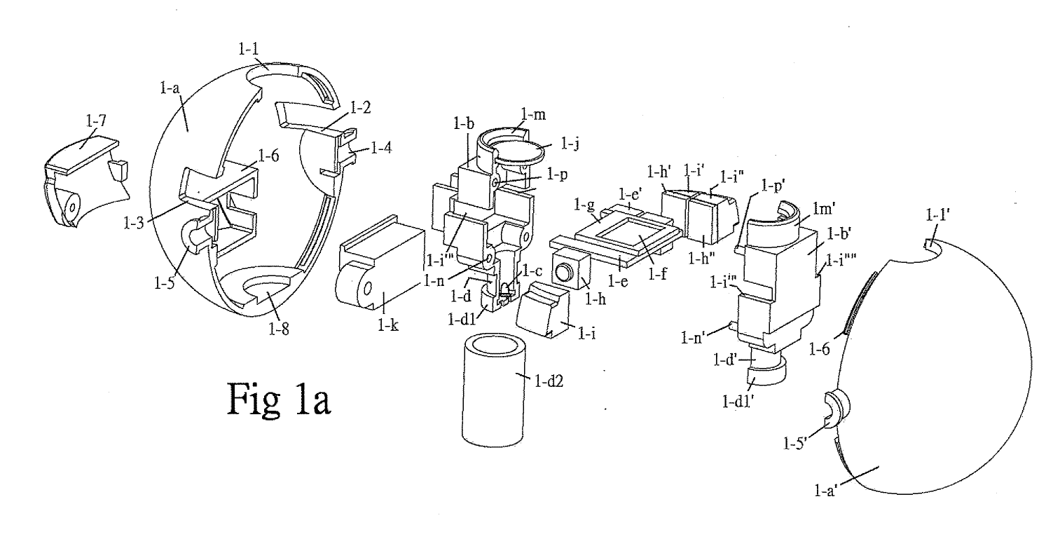

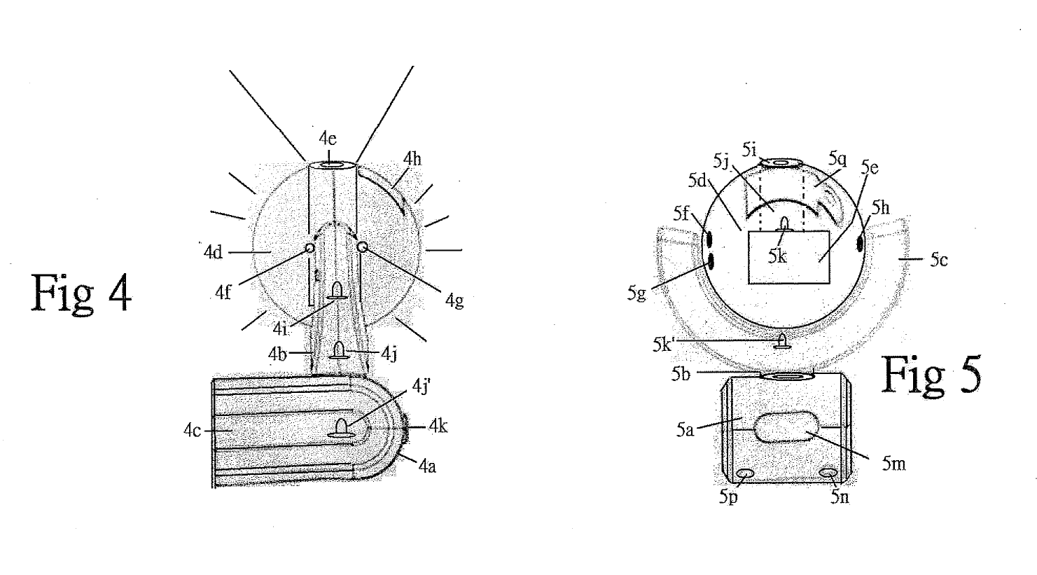

From FIG. 2 and FIG. 3 and FIG. 4 and FIG. 5: Disclosure the detail construction of the preferred embodiment 1. From FIG. 2 Show the time display project light has build-in project light (2d′) and night light (2d′) which is for a time project light (2f) which has housing (2e), more than one of LEDs (2d′) (2d″) (2j), prong means (2b), sensor means (2c), battery cover (not shown), batteries, time adjustable and setting switch(s) (2g) (2h), manual switch(s) (2c), photo sensor means (2c), inner circuit means (not shown), LCD display means (as FIG. 1-a), digital data display means (as FIG. 1-a), swivel or rotate or spin means to allow the project head change position, base spin or swivel or rotate means (housing has movable features such as Y-frame or ball can rotate or spin), retractable or foldable prong means, housing means can install prong means or energy storage means such as batteries, switch means arrange on desired location on balls or base, time related parts & accessories (as FIG. 1-a) arranged in one area instead of too many electric signal delivery needed while arrange more than one area. These FIG. 2, FIG. 3, FIG. 4, FIG. 5 illustrations show all the FIG. 1 and FIG. 1-a preferred construction for time projection light has build-in time related parts & accessories and all preferred construction.

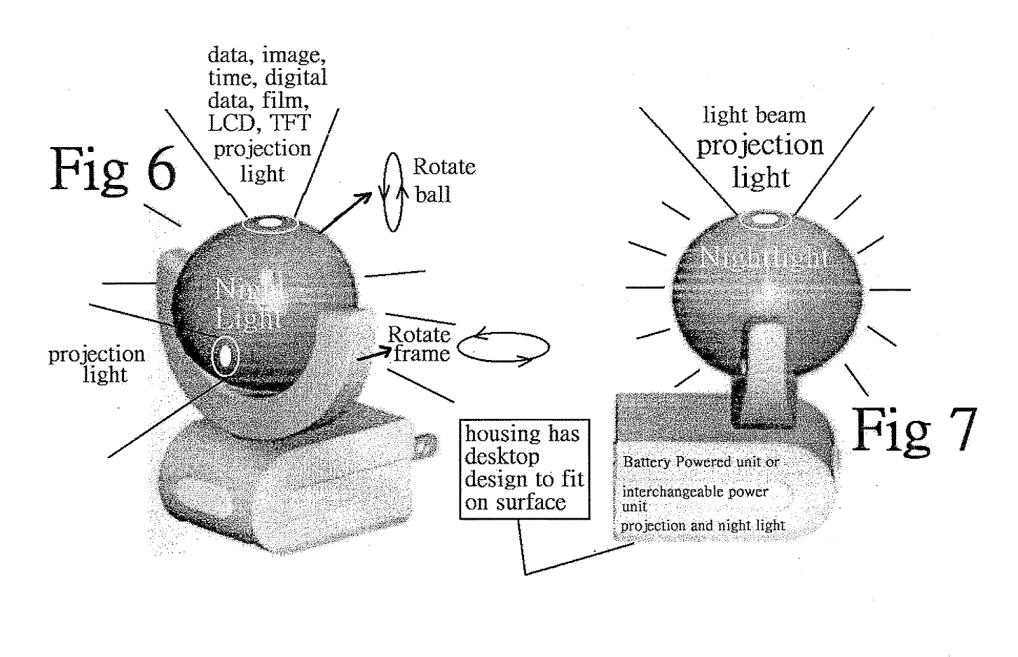

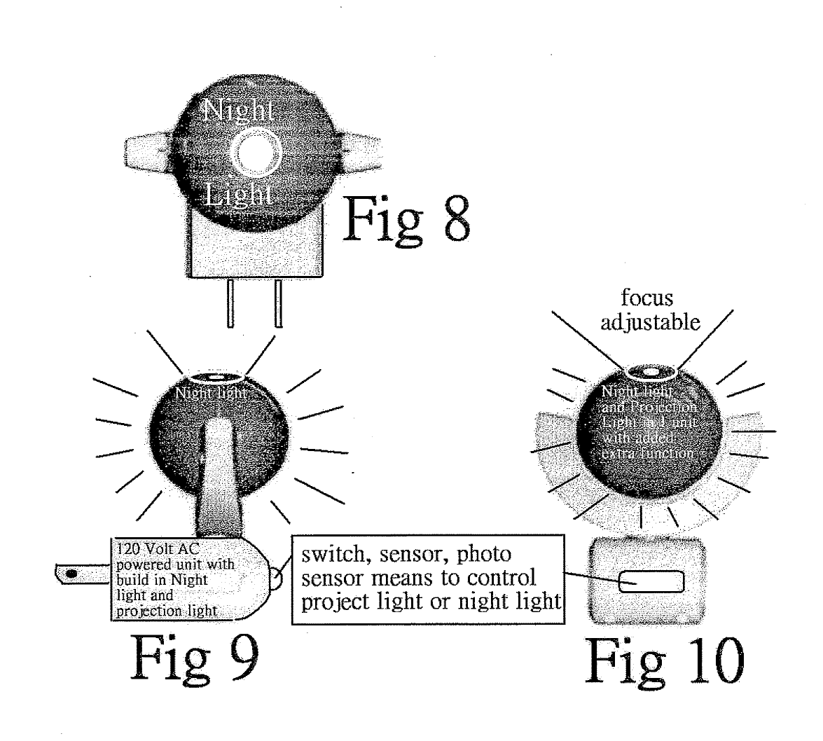

FIG. 6, FIG. 7, FIG. 8, FIG. 9, FIG. 10: Disclosure the above FIG. 1,1-a,2,3,4,5 for the functions of build-in project light and night light from different viewing angle.

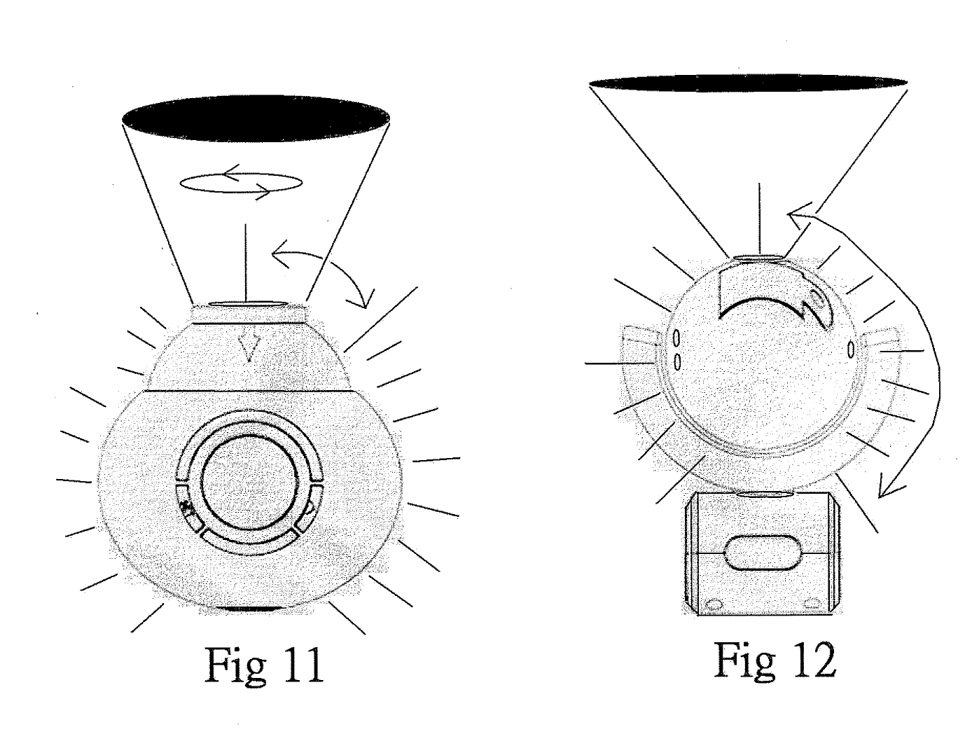

FIG. 11, FIG. 12: Disclosure the preferred FIGS. 1 to 10 embodiment with different shape of co-pending filing case preferred embodiment of Series number (12/624,621) FIG. 16-1 of prior filing case # I I and co-pending filing “LED projection light has more than one function” FIG. 5 and FIG. 5-1 compare with current invention construction. Current invention can has horizon 0 to 360 degree and vertical 0-360 degree to make image project to anywhere. The earlier prior filing which can have horizon 0 to 360 degree but the Vertical has limited angles to make image projection for some limitation not anywhere. Because the current one the housing can be removable (Y-Frame can be rotating 0 to 360 degree and ball itself can rotate from 0 to 360 degree).

The current invention for LED light has both project light and night light for at least 2 functions for said LED light which is unique. It is appreciated that any alternative, revised, amendment, improvement as long as will get the similar or equivalent of function, performance, effects, result still fall within the current invention scope for said LED light which as long as has build in project light and night light still fall within the current invention claims.

1. The LED light has project light and night light, The consist of:
At least one project light has desired parts & accessories may select from group combination from tubular assembly means, telescope means, optics lens means, been display-unit means, film, LCD means, TFT means, digital data means, wireless digital means, time piece means, weather means, screen means, light block out means, fix means, transparent means, translucent means, opening means, cut-out means, LED means, light means, lens assembly to project image, time, weather, message, display, digital data, cartoon characters, advertisement, seasonal data, promotion art, light beams only, or any geometric art, drawing, photos, negative, positive film, LCD screen image, TFT screen image, display-unit, or any signals, message that people eyes can be recognized to people to be seen by people eye.
At least one nigh light which can offer the light illumination to people at night time to see environment.
The projection light and night light can be turn on and turn off under pre-determined function, effects, performance while incorporate with group selection from switch means, sensor means, manual control means, automatically control means, wireless control means, IC chip(s), conductive means, power source means, outlet means, prong means, battery means, energy storage means, digital data means, wireless digital data means, Wifi means, motor means, gear set means, display means, screen means, LCD means, TFT means, focus adjustable means, rotate means, spin means, swivel mean, tile means, catcher means, lens, optics lens, change been display-unit means, tubular means, light block out means, light concentrate means, adaptor means, transformer means, energy supply means to make which are available from market place.
The Improvement including:
The said project light which has image present on surface which has distance from project head to surface is longer than people's arm length and clear image present on walls or ceiling or long distance surface.
The said LED light has base surface to allow said LED light install on the surface and keep the position or orientation on surface well without any movement.
The said project light and build-in night light can be turn on and turn off by automatically or manual arrangement with desired timing, period of time, duration, light performance, light function, light effects under pre-determined design to each other.
The said project light has project means which can change position of the projection direction by swivel means, rotate means, spin means.

2. The LED light has build-in project light and night light as claim 1, the said project light has swivel, rotate, spin construction to make the said project light's project head can change position, orientation, direction.

3. The LED light has build-in project light and night light as claim 1, the said project light has focus adjustable function.

4. The LED light has build-in Project light and night light as claim 1, the said project light has more than one project light or project means or project heads.

5. The LED light has build-in project light and night light as claim 1, The project light has nothing of the display-unit so only project the light beam to surface.

6. The LED light has build-in project light and night light as claim 1, the Project light has housing means and allow the housing parts can be movable for position or orientation changeable to make project light can project to wide range of 3 dimensions.

7. The LED light has build-in project light and night light as claim 1, the The night light can turn on and turn off to offer illumination to people for wide range areas.

8. The LED light has build-in project light and night light as claim 1, the Project light and night light incorporated with IC means, timer means, time delay means to get pre-determined preferred function(s), effects(s), performance(s) which available from market available light design.
